(19) United States
(12) Patent Application Publication
(10) Pub. No.: US 2018/0351224 A1
(43) Pub. Date: Dec. 6, 2018

(54) METAL-AIR BATTERY APPARATUS AND OPERATION METHOD THEREOF

(71) Applicant: SAMSUNG ELECTRONICS CO., LTD., Suwon-si (KR)

(72) Inventors: Jeongsik Ko, Hanam-si (KR); Hyukjae Kwon, Suwon-si (KR); Jaejoon Oh, Seongnam-si (KR)

(21) Appl. No.: 15/877,562

(22) Filed: Jan. 23, 2018

(30) Foreign Application Priority Data
Jun. 1, 2017 (KR) 10-2017-0068660

(51) Int. Cl. H01M 12/06; H01M 10/617; H01M 10/654

(52) U.S. Cl. CPC H01M 12/06; H01M 10/654; H01M 10/617

(57) ABSTRACT

A metal-air battery apparatus includes a temperature controller for controlling temperatures of a positive electrode and a negative electrode. The temperature controller includes a monitoring unit that may be separated from the temperature controller. The temperature of at least one of the positive electrode and the negative electrode may be controlled by monitoring an internal condition of the metal-air battery apparatus.

### CROSS-REFERENCE TO RELATED APPLICATION

This application claims priority to Korean Patent Application No. 10-2017-0068660, filed on Jun. 1, 2017, and all the benefits accruing therefrom under 35 U.S.C. § 119, the content of which in its entirety is herein incorporated by reference.

### BACKGROUND

1. Field

Embodiments of the disclosure relate to a metal-air battery apparatus and a method of operation thereof, and more particularly, to a metal-air battery apparatus including a temperature controller.

2. Description of the Related Art

A metal-air battery includes a negative electrode capable of occlusion and emission of metal ions, such as Lithium (Li), a positive electrode capable of oxidation and reduction of oxygen in the air, and a metal ion conductive medium between the positive electrode and the negative electrode.

In the metal-air battery, metal ions emitted from the negative electrode and oxygen in the air on the positive electrode side react with one another and generate a metallic oxide during a discharging process. The generated metallic oxide is reduced to metal ions and air or oxygen during a charging process. Thus, both charging and discharging of the metal-air battery are possible. Since oxygen, i.e., a positive electrode active material, is available from the air, it may not be necessary to fill the positive electrode active material into the metal-air battery. Thus, the metal-air battery may, theoretically, have a larger capacity than that of a secondary battery using a solid positive electrode active material.

Also, a Li-air battery uses air in the atmosphere as the positive electrode active material, and thus, may have a substantially high energy density. Accordingly, the Li-air battery receives a lot of attention as a next-generation battery.

### SUMMARY

According to an embodiment of an embodiment, a metal-air battery apparatus includes a positive electrode, a negative electrode, and an ion conductive layer between the positive electrode and the negative electrode, and a temperature controller which controls temperatures of the positive electrode and the negative electrode.

In an embodiment, the temperature controller may include a monitoring element which monitors an internal condition of the metal-air battery apparatus.

In an embodiment, the metal-air battery apparatus may further include a monitoring unit which is spaced apart from the temperature controller and monitors an internal condition of the metal-air battery apparatus.

In an embodiment, the temperature controller may include a positive electrode temperature controller connected to the positive electrode and a negative electrode temperature controller connected to the negative electrode.

In an embodiment, the positive electrode temperature controller may directly contact the positive electrode.

In an embodiment, the negative electrode temperature controller may directly contact the negative electrode.

In an embodiment, the metal-air battery apparatus may further include a positive electrode thermally conductive layer in the positive electrode, the positive electrode thermally conductive layer connected to the positive electrode temperature controller.

In an embodiment, the metal-air battery apparatus may further include a positive electrode thermally conductive layer on one side of the positive electrode, and the positive electrode thermally conductive layer may be connected to the positive electrode temperature controller.

In an embodiment, the metal-air battery apparatus may further include a negative electrode thermally conductive layer on one side of the negative electrode, and the negative electrode thermally conductive layer may be connected to the negative electrode temperature controller.

According to another embodiment, an operation method of a metal-air battery apparatus includes presetting a temperature of at least one of a positive electrode and a negative electrode, monitoring an internal condition of the metal-air battery apparatus, and controlling a driving temperature of at least one of the positive electrode and the negative electrode upon determining, as a result of the monitoring of the internal condition of the metal-air battery apparatus, whether the temperature of the at least one of the positive electrode and the negative electrode is different from a preset temperature of the positive electrode or the negative electrode.

According to another embodiment, an operation method of a metal-air battery apparatus includes a first operation of presetting a temperature of at least one of a positive electrode and a negative electrode, a second operation of controlling the temperature of the at least one of the positive electrode and the negative electrode, a third operation of monitoring an internal condition of the metal-air battery apparatus, and a fourth operation of determining a necessity of changing the temperature of at least one of the positive electrode and the negative electrode, according to the internal condition of the metal-air battery apparatus.

### BRIEF DESCRIPTION OF THE DRAWINGS

These and/or other embodiments will become apparent and more readily appreciated from the following description of the embodiments, taken in conjunction with the accompanying drawings in which:

FIG. 1 is a cross-sectional view of an embodiment of a metal-air battery apparatus;

FIG. 2 is a cross-sectional view of an embodiment of a metal-air battery apparatus;

FIG. 3 is a cross-sectional view of an embodiment of a metal-air battery apparatus;

FIG. 4 is a cross-sectional view of an embodiment of a metal-air battery apparatus;

FIG. 5 is a flow chart of an embodiment of an operation method of a metal-air battery apparatus;

FIG. 6 illustrates an algorithm for performing the operation method of the metal-air battery apparatus via continuous monitoring; and

FIG. 7 is a graph of energy density of the metal-air battery apparatus with respect to charging/discharging cycles at a high temperature and a low temperature.

### DETAILED DESCRIPTION

Reference will now be made in detail to embodiments, examples of which are illustrated in the accompanying drawings, wherein like reference numerals refer to like elements throughout. In this regard, the illustrated embodiments may have different forms and should not be construed as being limited to the descriptions set forth herein. Accordingly, the embodiments are merely described below, by referring to the drawing figures, to explain embodiments. Expressions such as “at least one of,” when preceding a list of elements, modify the entire list of elements and do not modify the individual elements of the list.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this invention will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third,” etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an embodiment, when the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

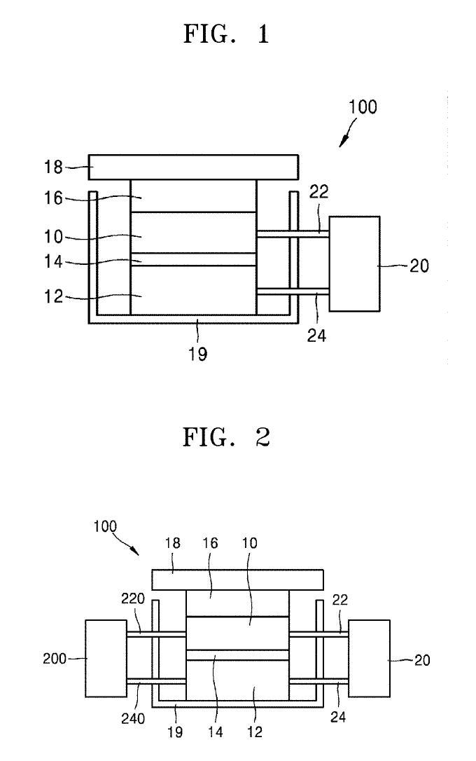

FIG. 1 is a cross-sectional view of a metal-air battery apparatus 100 according to an embodiment.

Referring to FIG. 1, a metal-air battery apparatus 100 may include a positive electrode 10 capable of oxidation and reduction of oxygen in the air and a negative electrode 12 capable of occlusion and emission of metal ions. An ion conductive layer 14 may be disposed between the positive electrode 10 and the negative electrode 12. A positive electrode collector 18 and a diffusion layer 16 may be disposed on one side of the positive electrode 10, and a negative electrode collector 19 may be disposed on one side of the negative electrode 12. The positive electrode 10, the negative electrode 12, the ion conductive layer 14, the diffusion layer 16, and the positive and negative electrode collectors 18 and 19 may form a unit cell structure of the metal-air battery, and the unit cell structure may have a structure wrapped by a separate pouch, etc., for example.

The positive electrode 10 and the negative electrode 12 may each be connected to a temperature controller 20. The temperature controller 20 may control a temperature of the positive electrode 10 by a positive electrode temperature controller 22 directly connected to the positive electrode 10. In addition, the temperature controller 20 may control the temperature of the negative electrode 12 by a negative electrode temperature controller 24 directly connected to the negative electrode 12. Temperature control of the positive electrode 10 or the negative electrode 12 by the temperature controller 20 may include both decreasing and increasing the temperature of the positive electrode 10 or the negative electrode 12 under a current condition. The temperature controller 20 may, individually and independently, control the temperature of the positive electrode 10 and the temperature of the negative electrode 12. In an embodiment, the temperature of the negative electrode 12 may be decreased or increased while the temperature of the positive electrode 10 is maintained as is, and the temperature of the positive electrode 10 may be decreased or increased while the temperature of the negative electrode 12 is maintained as is, for example. In addition, the temperature of the negative electrode 12 may be decreased while the temperature of the positive electrode 10 is increased, or, on the contrary, the temperature of the negative electrode 12 may be increased while the temperature of the positive electrode 10 is decreased.

The temperature controller 20 may control the temperature of the positive electrode 10 or the negative electrode 12 to a high temperature or a low temperature. In an embodiment, the high temperature may be the temperature in a range of about 50 degrees Celsius (° C.) to about 70° C., for example. In an embodiment, the low temperature may be the temperature in a range of about 20° C. to about 40° C., for example. The temperature controller 20 may allow the positive electrode 10 to have the high temperature or the low temperature through the positive electrode temperature controller 22, and may allow the negative electrode 12 to have a temperature range corresponding to the high temperature or the low temperature through the negative electrode temperature control 24. The positive electrode temperature controller 22 may be connected in direct contact with the positive electrode 10, and the negative electrode temperature controller 24 may be connected in direct contact with the negative electrode 12.

The temperature controller 20 may include a monitoring element measuring an internal condition of the metal-air battery apparatus 100 in order to control temperatures of the positive electrode 10 and the negative electrode 12. The temperature of the positive electrode 10 may be measured through the positive electrode temperature controller 22, and the temperature of the negative electrode 12 may be measured through the negative electrode temperature controller 24. In addition, not only temperature conditions of the positive electrode 10 and the negative electrode 12 but also gas compositions inside the metal-air battery apparatus 100 may be measured.

When the positive electrode 10 and the negative electrode 12 are maintained at high temperatures when the metal-air battery apparatus is driven, high ion conductivity may be maintained, which may be advantageous for high output driving. When the positive electrode 10 and the negative electrode 12 are maintained at low temperatures, relatively low output driving may be obtained compared to a case when the positive electrode 10 and the negative electrode 12 are maintained at high temperatures, but an electrolyte side reaction may be suppressed and a relatively continuous output may be maintained even with an increase in charging/discharging cycles.

FIG. 2 is a cross-sectional view of a metal-air battery apparatus 100 according to an embodiment.

Referring to FIG. 2, the metal-air battery apparatus 100 may include a positive electrode 10 and a negative electrode 12, and further include an ion conductive layer 14 between the positive electrode 10 and the negative electrode 12. A positive electrode collector 18 and a diffusion layer 16 may be disposed on the positive electrode 10, and a negative electrode collector 19 may be on the negative electrode 12. The positive electrode 10 and the negative electrode 12 may each be connected to a temperature controller 20. The temperature controller 20 may control the temperature of the positive electrode 10 by a positive electrode temperature controller 22 directly connected to the positive electrode 10, and may control the temperature of the negative electrode 12 by a negative electrode temperature controller 24 directly connected to the negative electrode 12. The positive electrode temperature controller 22 directly contacts the positive electrode 10 and the temperature controller 20 may control the temperature of the positive electrode 10. In addition, the negative electrode temperature controller 24 may be extended from the temperature controller 20 and directly contact the negative electrode 12. The temperature controller 20 may control the temperature of the positive electrode 10 or the negative electrode 12 at either a high temperature or a low temperature. In an embodiment, the high temperature may be the temperature in a range of about 50° C. to about 70° C. and the low temperature may be the temperature in a range of about 20° C. to about 40° C., for example.

The metal-air battery apparatus 100 illustrated in FIG. 2 may further include a monitoring unit 200 monitoring and measuring the internal condition of the metal-air battery apparatus 100 in order to control temperatures of the positive electrode 10 and the negative electrode 12. The monitoring unit 200 may include a first measuring unit 220 and a second measuring unit 240. The first measuring unit 220 may connect the monitoring unit 200 and the positive electrode 10, and may be connected to the positive electrode 10 with a direct contact. The second measuring unit 240 may connect the monitoring unit 200 and the negative electrode 12, and may be connected to the negative electrode 12 with a direct contact. The metal-air battery apparatus illustrated in FIG. 2, unlike that in FIG. 1, indicates that the monitoring unit 200 is spaced apart from the temperature controller 20. The first measuring unit 220 and the second measuring unit 240 of the monitoring unit 200 may not only measure temperatures of the positive electrode 10 and the negative electrode 12 but also monitor various other features such as electrolyte conditions, kinds of generated gas compositions, charging/discharging profiles, etc., inside the metal-air battery apparatus 100.

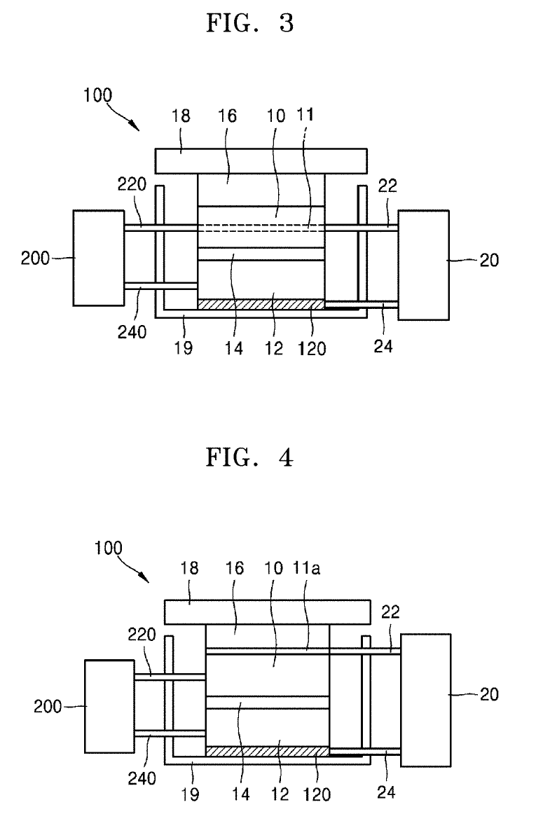

FIG. 3 is a cross-sectional view of a metal-air battery apparatus 100 according to an embodiment.

Referring to FIG. 3, the metal-air battery apparatus 100 may include a positive electrode 10 and a negative electrode 12, and further include an ion conductive layer 14 between the positive electrode 10 and the negative electrode 12. A positive electrode collector 18 and a diffusion layer 16 may be disposed on the positive electrode 10, and the negative electrode collector 19 may be on the negative electrode 12.

The positive electrode 10 and the negative electrode 12 may each be connected to a temperature controller 20. The temperature controller 20 may control the temperature of the positive electrode 10 by a positive electrode temperature controller 22 directly connected to the positive electrode 10, and may control the temperature of the negative electrode 12 by a negative electrode temperature controller 24 directly connected to the negative electrode 12. The positive electrode temperature controller 22 in FIG. 3, unlike cases in FIGS. 1 and 2, may not be directly connected to the positive electrode 10 but may be connected to a positive electrode thermally conductive layer 11 inside the positive electrode 10. The positive electrode thermally conductive layer 11 may control the temperature of the positive electrode 10 under a control of the temperature controller 20, either by transferring to the positive electrode 10 the heat transferred through the positive electrode temperature controller 22, or by emitting the heat from the positive electrode 10 to the positive electrode temperature controller 22. In addition, the negative electrode thermally conductive layer 120 may control the temperature of the negative electrode 12 under the control of the temperature controller 20, by transferring to the negative electrode 12 the heat transferred through the negative electrode temperature controller 24, or by emitting the heat from the negative electrode 12 to the negative electrode temperature controller 24.

FIG. 4 is a cross-sectional view of a metal-air battery apparatus 100 according to an embodiment.

Referring to FIG. 4, a positive electrode thermally conductive layer 11a may be disposed between a positive electrode 10 and a diffusion layer 16, unlike in the metal-air battery apparatus 100 illustrated in FIG. 3. One side of the positive electrode thermally conductive layer 11a may directly contact the positive electrode 10 and the other side may directly contact the diffusion layer 16 disposed thereon. The positive electrode thermally conductive layer 11a may control the temperature of the positive electrode 10 either by transferring to the positive electrode 10 the heat transferred through the positive electrode temperature controller 22 from the temperature controller 20, or by emitting the heat from the positive electrode 10 to the positive electrode temperature controller 22.

The positive electrode 10 may include a conductive material capable of oxidation or reduction of oxygen in the air and there is no limit in selection of materials. In an embodiment, the positive electrode 10 may use carbon-based materials, and may also use graphite, graphene, carbon black, carbon fiber, etc., for example. In an embodiment, the conductive material such as a metal fiber and a metal mesh may be used as a positive electrode active material, and a metal powder of copper, silver, nickel, aluminum, etc., may be also used. In an embodiment, an organic conductive material may be used. These conductive materials may be used individually or as a mixture. In an embodiment, the positive electrode 10 may include a binder of a thermoplastic resin, a thermosetting resin, etc., and may include an ion conductive polymer electrolyte, for example. In an embodiment, a catalyst for oxidation or reduction of oxygen may be added to the positive electrode 10, for example. Other positive electrode materials used in the metal-air battery apparatus may be used without limit. The positive electrode 10 may be provided by preparing a mixture through mixing the catalyst for oxidation or reduction of oxygen and the binder with conductive materials, adding a solvent to this mixture, coating the mixture onto one side or both sides of the positive electrode collector 18 or the positive electrode thermally conductive layer 11a, and drying up the mixture. In an embodiment, the positive electrode thermally conductive layer 11a may be a metal material layer having a mesh shape, for example.

The negative electrode 12 may include a Lithium metal thin film, and also other negative electrode active materials excluding Lithium metal, for example. The negative electrode 12 may be manufactured by negative electrode active material composites including a negative electrode active material, a conductive agent, a binder and a solvent, for example. The negative electrode 12 may be manufactured in a form of an alloy, a compound or a mixture by additionally including other negative electrode active material along with Lithium metal, for example. In an embodiment, other negative electrode active materials excluding Lithium may include at least one of metals formable with Lithium as alloys, transition metal oxides, non-transition metal oxides, and carbon-based materials, for example. In an embodiment, transition metal oxides may include Lithium Titanium oxide, Vanadium oxide, Lithium Vanadium oxide, etc., for example. In an embodiment, carbon-based materials may include crystalline structure carbon, amorphous carbon or their compounds, for example. The negative electrode 12 may be provided by directly coating the negative electrode active composite onto the negative electrode collector 19 or the negative electrode thermally conductive layer 120, after manufacturing a negative electrode active composite. In an alternative embodiment, after casting a negative electrode active material layer in a separate supporting fixture, the negative electrode 12 may be provided by bonding the negative electrode active material layer peeled off from the supporting fixture onto the negative electrode collector 19 or the negative electrode thermally conductive layer 120.

The ion conductive layer 14 may be an active metal ion conductive layer having a conductivity to an active metal ion and may include an ion conductive solid membrane. The ion conductive solid membrane may be a composite membrane including a porous organic membrane having pores and an ion conductive polymer electrolyte inside pores. In an embodiment, the porous organic membrane may include, for example, a porous film including a polymer non-woven fabric such as non-woven fabric including polypropylene, non-woven fabric including polyimide, and non-woven fabric including polyphenylene sulfide, and an olefin resin such as polyethylene, polypropylene, polybutene, and polyvinylchloride, but it is not limited thereto and any material usable for the porous organic membrane in the art may be utilized. The ion conductive layer 14 may be either a single layer or a multilayer. When the ion conductive layer 14 is in a multilayer structure, the multilayer structure may include a composite membrane capable of blocking gas and moisture, and a polymer electrolyte membrane. A separator may further be disposed between the positive electrode 10 and the negative electrode 12. However, the ion conductive layer 14 may function as the separator, and the separator may be selectively spaced apart from the ion conductive layer 14. In addition, separators conventionally used in the metal-air battery apparatus 100 may be used without limit. In an embodiment, the separator may include a porous film including a polymer non-woven fabric such as non-woven fabric including polypropylene and polyphenylene sulfide, and an olefin resin such as polyethylene and polypropylene, for example.

The positive electrode collector 18 and the negative electrode collector 19 may use metallic materials without limit, as long as metallic materials have a good conductivity. In an embodiment, the positive electrode collector 18 and the negative electrode collector 19 may include materials such as Cu, Au, Pt, Ag, Ni, and Fe, but it is not limited thereto. In addition, the positive electrode collector 18 and the negative electrode collector 19 may include not only metals but also materials such as conductive metal oxides and conductive polymers. The positive electrode collector 18 and the negative electrode collector 19 may have a structure with a non-conductive material coated on one side of the positive electrode collector 18 and the negative electrode collector 19. The positive electrode collector 18 and the negative electrode collector 19 may have a flexibility of being bendable and have an elasticity of recovering back to original shapes.

The diffusion layer 16 may provide an air supply path for supplying oxygen in the air to the positive electrode 10. The diffusion layer 16 may include a carbon fiber-based material such as a carbon paper. In addition, the diffusion layer 16 may be a porous membrane including organic compounds. The diffusion layer 16 may include a polymer of at least one of a homopolymer, a block copolymer and a random copolymer.

A term “air” used in the specification may include not only the air existing in the atmosphere but also a gas mixture including oxygen, and a pure oxygen gas.

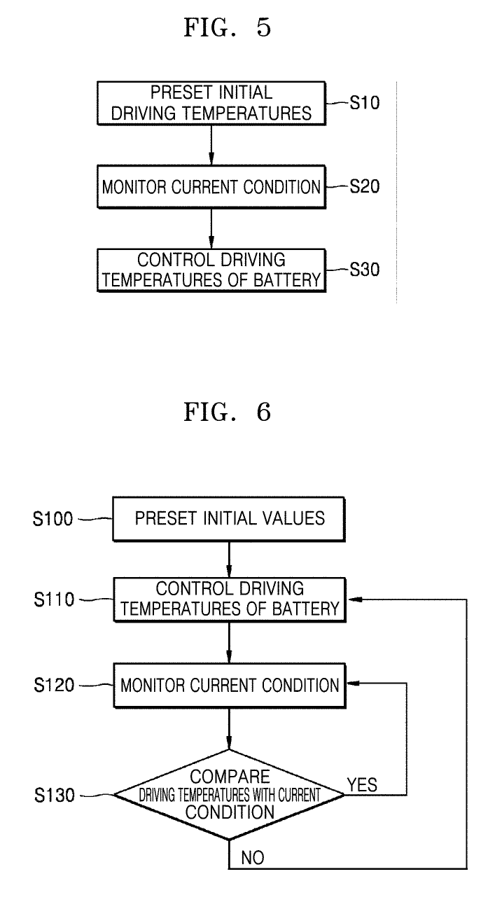

FIG. 5 is a flow chart of an operation method of a metal-air battery apparatus according to an embodiment.

Referring to FIG. 5, initial driving temperatures of a positive electrode 10 and a negative electrode 12 may be preset before operating a metal-air battery apparatus according to an embodiment (Operation S10). As described above, driving temperatures of the positive electrode 10 and the negative electrode 12 may each be preset at a high temperature or a low temperature. In an embodiment, the high temperature may be the temperature in a range of about 50° C. to about 70° C., for example. When the metal-air battery apparatus is driven in the temperature range of the high temperature of the positive electrode 10 and the negative electrode 12, the high ion conductivity may be maintained and the high output driving may be possible. In an embodiment, the low temperature may be the temperature in a range of about 20° C. to about 40° C., for example. When the metal-air battery apparatus is driven in the temperature range of the low temperature of the positive electrode 10 and the negative electrode 12, the electrolyte side reaction may be suppressed and a relatively stable output may be maintained despite an increase in charging/discharging cycles.

It is not necessary to preset simultaneously temperatures of the positive electrode 10 and the negative electrode 12 at the high temperature or at the low temperature. In other words, the positive electrode 10 may be preset at the high temperature and the negative electrode 12 may be preset at the low temperature. Or the positive electrode 10 may be preset at the low temperature and the negative electrode 12 may be preset at the high temperature. One of the positive electrode 10 and the negative electrode 12 may be selectively preset at either the high temperature or the low temperature. In an embodiment, only the negative electrode 12 may be preset at either the high temperature or the low temperature, for example. Setting temperatures of the positive electrode 10 and the negative electrode 12 may always use a default setting where empirically preset, default values are used, or a user selecting in which a user arbitrarily selects the temperature each time the metal-air battery apparatus is operated.

Then, the internal condition of the metal-air battery apparatus 100 may be monitored (Operation S20). A monitoring may be performed at the temperature controller 20, and may be separately performed by the monitoring unit 200. In a process of monitoring, temperatures of the positive electrode 10 and the negative electrode 12 may be measured, and in addition, electrolyte conditions, generated gas compositions, charging/discharging profiles, etc., inside the metal-air battery apparatus 100 may be monitored.

When there is a difference between a preset temperature and a monitored result of the internal condition of the metal-air battery apparatus 100, the driving temperature of either the positive electrode 10 or the negative electrode 12 inside the metal-air battery apparatus 100 may be controlled (Operation S30). The positive electrode temperature controller 22 and the negative electrode temperature controller 24, which are each connected to both the positive electrode 10 and the negative electrode 12, may be used in order to control driving temperatures of the positive electrode 10 and the negative electrode 12 of the metal-air battery apparatus 100. Heating or cooling of the positive electrode 10 and the negative electrode 12 by the temperature controller 20 may be performed by a high frequency induction heating method or a thermoelectric effect phenomenon of metals or semiconductors, but it is not limited thereto and various temperature control methods may be used without limit.

FIG. 6 illustrates an algorithm, where the operation method of the metal-air battery apparatus 100 may be performed via continuous monitoring. In FIG. 6, the operation method of the metal-air battery apparatus 100 is provided, where an operation control of the metal-air battery apparatus 100 may be possible via continuous monitoring of the internal condition of the metal-air battery apparatus 100.

Referring to FIG. 6, when the metal-air battery apparatus 100 according to an embodiment is operated, initial driving temperatures of the positive electrode 10 and the negative electrode 12 may be preset (Operation S100). Driving temperatures of the positive electrode 10 and the negative electrode 12 may be independently preset at the high temperature or the low temperature. Temperatures of the positive electrode 10 and the negative electrode 12 may be simultaneously preset at either the high temperature or the low temperature, but this is selective and the positive electrode 10 may be preset at the high temperature and the negative electrode 12 may be preset at the low temperature. On the contrary to this, the positive electrode 10 may be preset at the low temperature and the negative electrode 12 may be preset at the high temperature. In addition, one of the positive electrode 10 and the negative electrode 12 may be selectively preset at either the high temperature or the low temperature. Presetting temperatures of the positive electrode 10 and the negative electrode 12 may always use a default setting where empirically preset, default values are used, or a user selecting where a user arbitrarily selects temperatures each time the metal-air battery apparatus 100 is operated.

Temperatures of the positive electrode 10 and the negative electrode 12 may each be controlled per preset temperatures for the positive electrode 10 and the negative electrode 12 (Operation S110). Temperatures of the positive electrode 10 and the negative electrode 12 may be controlled by the positive electrode temperature controller 22 and the negative electrode temperature controller 24 which are each connected to the positive electrode 10 and the negative electrode 12 from the temperature controller 20.

Next, the internal condition of the metal-air battery apparatus 100 may be monitored (Operation S120). The monitoring of the metal-air battery apparatus 100 may be performed by the temperature controller 20 as illustrated in FIG. 1, or separately by the monitoring unit 200 as illustrated in FIG. 2. In a process of monitoring, temperatures of the positive electrode 10 and the negative electrode 12 may be measured, and in addition, electrolyte conditions, generated gas compositions, charging/discharging profiles, etc., inside the metal-air battery apparatus 100 may be monitored.

Then, after comparing the internal condition monitored in the operation S120 of the metal-air battery apparatus 100 with driving temperatures of the positive electrode 10 and the negative electrode 12, whether to maintain current temperatures of the positive electrode 10 and the negative electrode 12 as is may be determined (Operation S130). Here, conditions of the metal-air battery apparatus 100 may include temperatures of the positive electrode 10 and the negative electrode 12, but conditions excluding temperatures such as conditions of products due to the electrolyte side reaction and conditions of deposits disposed on a surface of the positive electrode 10 may be considered. Accordingly, after comparing the current conditions of the metal-air battery apparatus 100 with driving temperatures, a necessity of whether to change the temperature of at least one of the positive electrode 10 and the negative electrode 12 may be determined. In other words, it may be determined whether the temperature of at least one of the positive electrode 10 and the negative electrode 12 needs to be maintained at either the low temperature or the high temperature, or increased from the low temperature to the high temperature, or decreased from the high temperature to the low temperature.

When the internal condition of the metal-air battery apparatus 100 during operation thereof is determined as being stable and temperatures of the positive electrode 10 and the negative electrode 12 are to be maintained, the internal condition is considered to be “YES” and the monitoring at the operation S120 may be continuously performed. When the internal condition of the metal-air battery apparatus 100 during operation thereof is determined as being unstable and the temperature of at least one of the positive electrode 10 and the negative electrode 12 needs to be lowered from the high temperature to the low temperature, or the temperature of at least one of the positive electrode 10 and the negative electrode 12 needs to be increased from the low temperature to the high temperature in order to meet a high output demand, the internal condition is considered to be “NO” and the operation may proceed to the operation S110 of controlling the driving temperature.

Operation methods of the metal-air battery apparatus 100 illustrated in FIGS. 5 and 6 are compared. The operation method illustrated in FIG. 6 may be selected when the metal-air battery apparatus 100 is continuously operating or the continuous monitoring is needed for the metal-air battery apparatus 100. The operation method illustrated in FIG. 5 may be selected when the metal-air battery apparatus 100 operates for a relatively short duration, or with initial presetting values only.

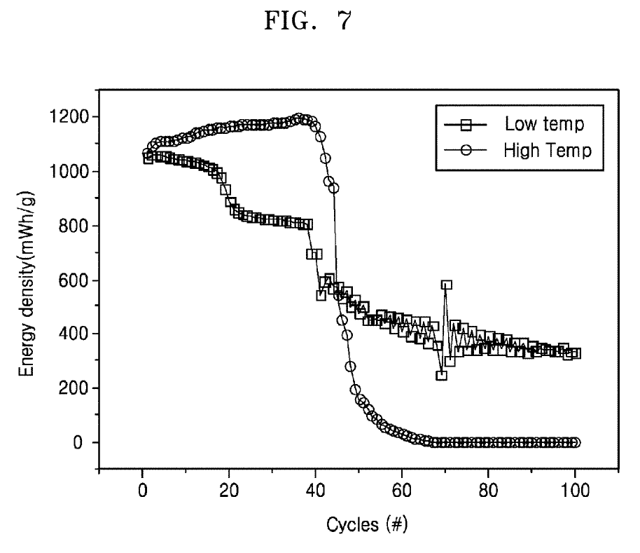

FIG. 7 is a graph indicating an energy density of the metal-air battery apparatus with respect to charging/discharging cycles at the high temperature and the low temperature.

Referring to FIG. 7, the energy density at a high temperature operation is larger than that at a low temperature operation, when charging/discharging cycles are low in a process of repeated charging/discharging operations at the high temperature and the low temperature. However, the energy density at the high temperature operation may abruptly decrease in a process of sufficiently repeated charging/discharging operations and increased cycles. The energy density may have a tendency of decreasing when charging/discharging is repeated at the low temperature operation, but the energy density shows a continuous stability, unlike an abrupt decrease at the high temperature operation. Thus, a stable operation may be possible when the internal condition of the metal-air battery apparatus 100 is continuously monitored and, at the same time, the high temperature operation and the low temperature operation are properly changed.

According to embodiments of the disclosure, the metal-air battery apparatus 100 may be provided with the temperature controller 20 capable of controlling driving temperatures of the positive electrode 10 and the negative electrode 12 of the metal-air battery apparatus 100. At least one temperature of the positive electrode 10 and the negative electrode 12 may be controlled via real-time monitoring of the internal condition of the metal-air battery apparatus 100. Thus, the metal-air battery apparatus 100 with enhanced cyclic characteristics and stability may be provided.

It should be understood that embodiments described herein should be considered in a descriptive sense only and not for purposes of limitation. Descriptions of features or embodiments within each embodiment should typically be considered as available for other similar features or other embodiments.

While one or more embodiments have been described with reference to the drawing figures, it will be understood by those of ordinary skill in the art that various changes in form and details may be made therein without departing from the spirit and scope as defined by the following claims.

What is claimed is:

1. A metal-air battery apparatus comprising:
a positive electrode, a negative electrode, and an ion conductive layer between the positive electrode and the negative electrode; and
a temperature controller which controls temperatures of the positive electrode and the negative electrode.

2. The metal-air battery apparatus of claim 1, wherein the temperature controller comprises a monitoring element which monitors an internal condition of the metal-air battery apparatus.

3. The metal-air battery apparatus of claim 1, further comprising:
a monitoring unit which is spaced apart from the temperature controller and monitors an internal condition of the metal-air battery apparatus.

4. The metal-air battery apparatus of claim 1, wherein the temperature controller comprises a positive electrode temperature controller connected to the positive electrode and a negative electrode temperature controller connected to the negative electrode.

5. The metal-air battery apparatus of claim 4, wherein the positive electrode temperature controller directly contacts the positive electrode.

6. The metal-air battery apparatus of claim 4, wherein the negative electrode temperature controller directly contacts the negative electrode.

7. The metal-air battery apparatus of claim 4, further comprising:
a positive electrode thermally conductive layer which is disposed in the positive electrode and connected to the positive electrode temperature controller.

8. The metal-air battery apparatus of claim 4, further comprising:
a positive electrode thermally conductive layer which is disposed on one side of the positive electrode and connected to the positive electrode temperature controller.

9. The metal-air battery apparatus of claim 4, further comprising:
a negative electrode thermally conductive layer which is disposed on one side of the negative electrode and connected to the negative electrode temperature controller.

10. An operation method of a metal-air battery apparatus, the operation method comprising:
presetting a temperature of at least one of a positive electrode and a negative electrode;
monitoring an internal condition of the metal-air battery apparatus; and
controlling a driving temperature of at least one of the positive electrode and the negative electrode upon determining, as a result of the monitoring the internal condition of the metal-air battery apparatus, whether the temperature of the at least one of the positive electrode and the negative electrode is different from a preset temperature of the at least one of the positive electrode and the negative electrode.

11. The operation method of claim 10, wherein the driving temperature of the at least one of the positive electrode and the negative electrode is from about 20 degrees Celsius to about 40 degrees Celsius or from about 50 degrees Celsius to about 70 degrees Celsius.

12. An operation method of a metal-air battery apparatus, the method comprising:
a first operation of presetting a temperature of at least one of a positive electrode and a negative electrode;
a second operation of controlling the temperature of the at least one of the positive electrode and the negative electrode;
a third operation of monitoring an internal condition of the metal-air battery apparatus; and
a fourth operation of determining a necessity of changing the temperature of the at least one of the positive electrode and the negative electrode, according to the internal condition of the metal-air battery apparatus.

13. The operation method of claim 12, wherein one of the second operation and the third operation is executed again after the fourth operation of determining the necessity of changing the temperature of the at least one of the positive electrode and the negative electrode.

14. The operation method of claim 12, wherein the second operation, the third operation, and the fourth operation are executed again when the necessity of changing the temperature of the at least one of the positive electrode and the negative electrode is confirmed.

15. The operation method of claim 12, wherein the third operation of monitoring the internal condition of the metal-air battery apparatus is executed again when the necessity of changing the temperature of the at least one of the positive electrode and the negative electrode is not confirmed.
